(19) United States
(12) Patent Application Publication
(10) Pub. No.: US 2011/0032415 A1
(43) Pub. Date: Feb. 10, 2011

(54) A Case For A Digital Camera

(76) Inventor: Andrzej Sadowski, Bydgoszcz (PL)

Correspondence Address: WILLIAM J. SAPONE;COLEMAN SUDOL SAPONE P.C., 714 COLORADO AVENUE, BRIDGE PORT, CT, 06605, US

(21) Appl. No.: 12/921,420

(22) PCT Filed: Mar. 10, 2009
(86) PCT No.: PCT/PL09/00021

§ 371 Date: Oct. 26, 2010

(30) Foreign Application Priority Data
Mar. 10, 2008 (PL) P.384648

(51) Int. Cl. H04N 5/225

(52) U.S. Cl. 348/373; 348/E05.024

(57) ABSTRACT

This invention relates to a case (3) for a digital camera (4) which comprises at least a first opening (1) and at least a second opening (2), situated oppositely to each other. Said first opening (1) is an observation opening and said second opening (2) has a shape and size which substantially conforms to the shape and size of LCD display (5) of the camera (4). Therefore the case (3) according to the invention besides its primary function of storing a camera serves also as a highly efficient antisolar cover and view-finder, while it does not require using any other additional arrangements installed on a camera.

### TECHNICAL FIELD

The invention relates to a case for a digital camera.

### BACKGROUND

Digital cameras provided with LCD displays allow observing and composing photographed objects during taking a picture. Some digital cameras are not even provided with a view-finder so that user of such a camera holds it at some distance from the eyes in order to be able to observe the photographed scene on LCD display. Using LCD displays in this manner is however inconvenient.

During photographing at large level of insolation it is difficult to cover LCD display against sunbeams, since the light reflected from LCD display causes that the view on the display is invisible. When photographing distanced objects at large zoom-in level, holding a camera distanced from a head in hands in order to observe the scene on the LCD display is disadvantageous, as it results in poor stability of the camera. Observing LCD displays is also difficult for persons using reading glasses as in order to take a picture using camera without a view-finder the person has to put on the glasses.

Known covers for LCD displays such as disclosed in patent application U.S. 2002/0097997 A1 or viewing devices such as disclosed in patent application U.S. 2008/0082682 A1 may be attached on the camera as add-on devices if necessary. Main drawback of such covers and view-finders is a necessity of mounting them on a camera and then demounting before putting a camera back into a case. It is significant inconvenience causing that the add-on covers and view-finders of this type are not popular and presently not commercially available.

According to the invention there is provided a case for a digital camera, which comprises at least a first opening and at least a second opening, situated oppositely to each other, wherein said first opening is an observation opening and said second opening has a shape and size which substantially conforms to the shape and size of LCD display of the camera.

Preferably said second opening is also an opening for putting in and taking out the camera from the case.

Preferably said first observation opening is provided with a lens, in particular magnifying lens and/or lens installed on a slidable element, or provided with a pane.

Moreover it is advantageous if at least one of the openings is provided with a cover.

The case according to the invention besides its primary function of storing a camera serves also as a highly efficient antisolar cover and a view-finder, while it does not require using any other additional arrangements installed on a camera.

### BRIEF DESCRIPTION OF THE DRAWINGS

The invention is illustrated below with reference to the preferred exemplary embodiments thereof and with reference to the attached drawings on which:

FIG. 1 shows a manner of using a case according to the invention as an antisolar cover and view-finder during photographing;

FIG. 2 shows an axonometric view of the case shown in FIG. 1;

FIG. 3 shows an axonometric view of another exemplary embodiment of a case according to the invention; and

FIG. 4 shows cross-sectional partial view of the bottom part of the case from FIG. 3.

### DETAILED DESCRIPTION OF THE INVENTION

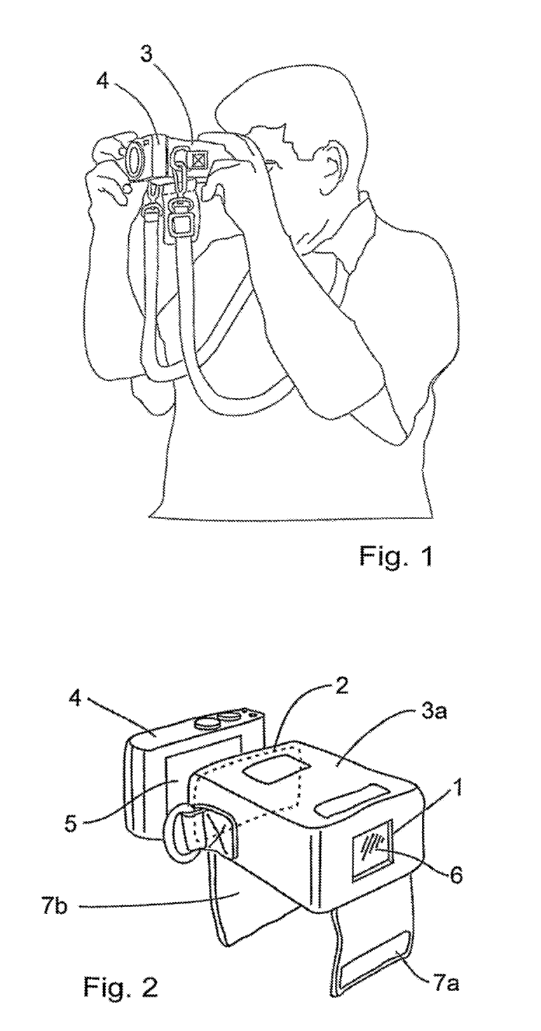

FIG. 1 illustrates a user which observes LCD display of a digital photographic camera 4 through an observation opening in a case 3.

FIG. 2 shows an embodiment of the case 3a according to the invention which is provided with an observation opening 1 in which a lens 6 is installed. The dashed line depicts a second opening 2 through which the camera may be put in and out of the case 3, while in this embodiment the second opening 2 serves also as the opening for observation of the LCD display 5. The case 3a is also provided with a cover 7a for the observation opening 1 and with a cover 7b for the second opening 2.

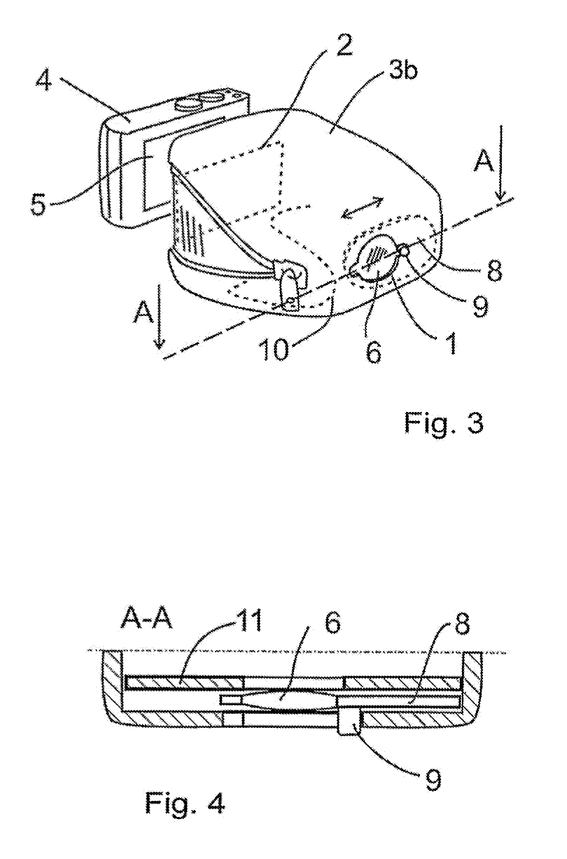

Another exemplary embodiment of a case 3b is depicted on FIG. 3. In this embodiment the observation opening 1 is provided with an element 8 mounted slidably on which a lens 6 is placed. A projection 9 enables sliding the element 8. A spring 10 ensures a steady state of the case 3b in unfolded position.

Cross-sectional view presented on FIG. 4 shows the slidably mounted element 8 which is located behind an internal baffle 11 of the case 3b. After sliding displacement of the element 8, the lens 6 covers between an external wall of the case 3b and the internal baffle 11, wherein the slidable element 8 covers up the observation opening 1.

Although in the presented embodiments of the invention a case is provided with two openings, wherein the second openings serves both as opening attached to LCD display and an opening used for putting a camera respectively in and out from the case, it is obvious that a case according to the invention may be provided with any other number of openings, such as for example three openings while two of them shall be situated oppositely and remaining ones being shall serve for putting a camera in and taking it out from the case.

In the basic embodiment of the invention the observation openings may have a form of simple port. However it is obvious that in these openings transparent baffles, such as for example lenses or panes made of glass or any other suitable plastic material, may be installed, thus ensuring tightness of a cover.

In order to improve a quality of visibility of a LCD display, an observation opening lens is a magnifying lens appropriately selected taking into account a size of LCD display and a distance between the first and the second opening. Finally it is obvious that each of the observation openings, despite an external cover, may additionally be provided with a suitable internal cover.

The embodiments above should not be, by any means, considered as exhaustive and/or limiting the invention, the spirit of which is characterized in the appended claims.

1. A case for a digital camera, characterised in that, it comprises at least a first opening (1) and at least a second opening (2), situated oppositely to each other, wherein said first opening (1) is an observation opening and said second opening (2) has a shape and size which substantially conforms to the shape and size of LCD display (5) of the camera (4).

2. The case according to claim 1, characterised in that, said second opening (2) is an opening for putting in and taking out the camera (4) from the case (3).

3. The case according to claim 1, characterised in that, said first observation opening (1) is provided with a lens (6).

4. The case according to claim 1, characterised in that, the lens (6) is a magnifying lens.

5. The case according to claim 1, characterised in that, said first observation opening (1) is provided with a pane.

6. The case according to claim 1, characterised in that, at least one of the openings (1, 2) is provided with a cover (7a, 7b).

7. The case according to claim 3, characterised in that, the lens (6) is installed on a slidable element (8).
